(19) United States
(12) Patent Application Publication
(10) Pub. No.: US 2018/0023547 A1
(43) Pub. Date: Jan. 25, 2018

(54) Hybrid Wind-Solar Power Generation System

(71) Applicant: Larry Jeffus, Elkhart, KS (US)

(72) Inventor: Larry Jeffus, Elkhart, KS (US)

(21) Appl. No.: 15/214,149

(22) Filed: Jul. 19, 2016

(51) Int. Cl. F03D 9/00; H02S 10/12; B08B 5/02; F03D 7/04

(52) U.S. Cl. CPC F03D 9/007; F03D 7/042; F03D 9/002; H02S 10/12; B08B 5/02; H02P 2101/15

(57) ABSTRACT

Electrical power may be generated by a system employing wind and solar energy capturing means. A wind turbine can be connected to a controller and have at least one blade connected to an electrical generator. A pressure vessel may be pneumatically connected to at least one nozzle that is attached proximal the wind turbine. A compressor can be connected to the pressure vessel and the controller so that the compressor is operated via electricity produced by the electrical generator. At least one solar panel that is positioned proximal the at least one nozzle can clean a solar panel with compressed air from the pressure vessel in response to the controller.

### SUMMARY OF THE INVENTION

A power generation system, in accordance with various embodiments, has a wind turbine connected to a controller with at least one blade connected to an electrical generator. A pressure vessel is pneumatically connected to at least one nozzle that is attached proximal the wind turbine. A compressor is connected to the pressure vessel and the controller so that the compressor is operated via electricity produced by the electrical generator. At least one solar panel that is positioned proximal the at least one nozzle cleans a solar panel with compressed air from the pressure vessel in response to the controller.

### BRIEF DESCRIPTION OF THE DRAWINGS

FIG. 1 provides a block representation of an example power generation system arranged in accordance with some embodiments.

FIG. 2 shows a line representation of a portion of an example power generation system configured in accordance with various embodiments.

FIG. 3 displays a line representation of a portion of an example turbine blade that may be employed in the power generation system of FIGS. 1 & 2.

FIG. 4 is a line representation of a portion of an example power generation system constructed and operated in accordance with assorted embodiments.

FIG. 5 conveys a line representation of an example nacelle capable of being utilized in the power generation system of FIGS. 1 & 2.

FIG. 6 provides a flowchart of an exemplary power generation routine carried out with the power generation system of FIGS. 1-5.

### DETAILED DESCRIPTION

Assorted embodiments of the present disclosure are generally directed to structures and methods that generate electrical power from multiple different naturally occurring energy sources, such as solar and wind energy.

Although wind and solar harnessing technologies have been respectively utilized in commercial and residential applications, there are a number of inefficiencies that plague the conversion of natural energy to electrical energy. For example, a solar collecting panel can become dirty and/or damaged over time and wind turbines can only generate electricity at specific wind speed ranges, which degrades the percentage of potential energy that can be converted to electricity by the respective technologies. It is contemplated that electricity generated by a wind turbine can be used by a gas compressor to pressurize gas, such as air, that can subsequently be used to increase the efficiency of the wind turbine. Pressurized air may further be used in combination with solar panels to provide an optimized hybrid power generation system that concurrently, or individually, converts wind and solar energy to electricity.

Accordingly, a hybrid power generation system can be arranged with a wind turbine working in concert with a pressure vessel and at least one solar panel to increase the conversion efficiency of the solar panel as well as the electricity-generating wind speed range of the wind turbine. The use of a pneumatic nozzle can allow a hybrid power generation system to clean a solar panel, move a solar panel, deploy a solar panel, and move portions of a wind turbine to enhance the operation, reliability, and longevity of the respective wind and solar energy generation means.

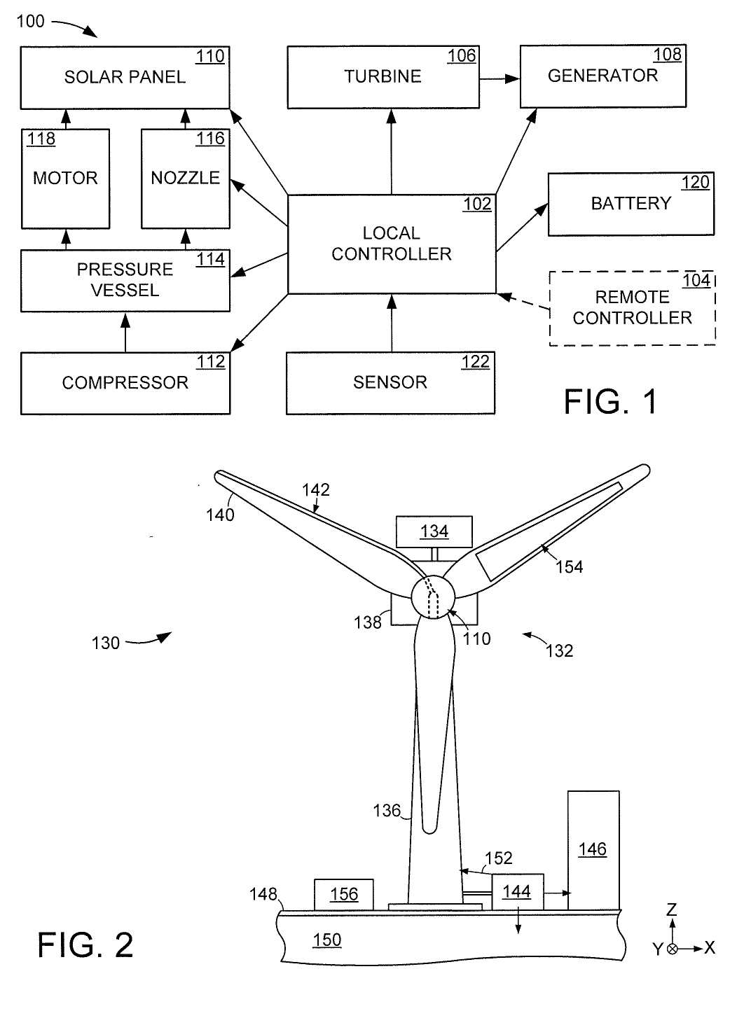

FIG. 1 is a block representation of an example hybrid power generation system 100 configured in accordance with some embodiments. The system 100 can have one or more local, or remote, controllers 102, such as a microprocessor. For example, a local controller 102 can work in concert with a remote controller 104 that is physically located off-site, such as in a different city, state, or country, and accessed via on-line communications, such as a cloud computing network. The use of local 102 and/or remote 104 controllers can provide robust computing capabilities that allow for the collection, processing, and interpretation of data to generate electricity from a wind turbine 106, turbine generator 108, and solar panel 110.

The controller(s) 102/104 can direct energy produced from the turbine generator 108 to a compressor 112 in order to create a volume of pressured gas in one or more pressure vessels 114. The stored gas in the pressure vessel(s) 114 can then be expelled by at least one pneumatic nozzle 116 to alter the operating conditions of the wind turbine 106 and/or the solar panel 110. Pressurized gas may further be used to activate a motor 118, or solenoid, that physically moves, or uncovers portions of the wind turbine 106 and/or solar panel 110.

The controller(s) 102/104 can collect data from one or more sensors, such as temperature, humidity, acoustic, pressure, light, motion, and proximity sensors, in order to make intelligent decisions about when and how to utilize stored pressurized gas. For instance, the local controller 102 can identify from a UV light sensor that solar power generation is optimal and direct pressurized air to clean, uncover, and/or move a solar panel 110 to optimize the conversion of solar energy into electrical energy in a battery 120. The decision to use pressurized air for solar panel optimization can be chosen by the controller 102 in response to collected data instead of using the pressurized gas to alter the wind turbine 106.

The ability to intelligently collect and interpret data collected from an environment allows the wind turbine 106 and solar panel(s) 110 to perform at heightened efficiency compared to configurations where pressurized gas is not intelligently employed. The interpretation of data may further allow pressurized gas to be used to proactively protect portions of the wind turbine 106 and solar panel(s) 110 by moving, or covering, them. For example, a sensor 122 can detect incoming weather and/or flying debris and the controller 102 can use pressurized gas to continuously flow air over the solar panel 110, move the solar panel 110, cover the solar panel 110, and tilt a turbine blade in order to reduce the risk of particles impacting and damaging portions of the wind turbine 106 and solar panel(s) 110.

FIG. 2 illustrates a line representation of a portion of an example hybrid power generation system 130 configured in accordance with assorted embodiments. Although not required or limiting, the hybrid system 130 has a wind turbine 132 to harness wind energy and one or more solar panels 134 to harness solar energy. The wind turbine 132 has a tower 136 that supports a nacelle 138 in which an electrical generator is positioned and operated by the turbine blades 140.

A pneumatic support system 142 can be incorporated into one or more turbine blades 140. As shown, a pneumatic support system 142 can be positioned on an edge (trailing or leading) of the turbine blade 140 to allow a nozzle to expel compressed air to alter the operation of the wind turbine 132. For example, compressed air can be released by the pneumatic support system 142 to start, slow down, or speed up rotation of the turbine blades 140, which can increase the range of wind speeds that allow the generator to produce electricity. At least a portion of the electricity produced by the generator of the wind turbine 132 can be directed to a local, or remotely located, gas compressor 144 that takes atmospheric air at a low pressure to a higher pressure that is maintained in at least one pressure vessel 146.

A pressure vessel 146 can be any size, shape, material, and location that can maintain an elevated gas pressure, such as above 100 psi, over time. For instance, a pressure vessel 146 may be a rigid tank that is above ground-level 148, a flexible bladder positioned in the tower 136, or a geological formation 150 positioned below ground-level 148, as respectively illustrated solid arrows 152. The compressor 144 may concurrently, or sequentially, pressurize any one, or more, pressure vessel(s) 146 to ensure ample volume of pressurized gas to alter the rotation of the turbine blades 140.

In the non-limiting example shown in FIG. 2, a first solar panel 134 is positioned atop the wind turbine nacelle 138, a second solar panel 154 is attached to a turbine blade 140, and a third solar panel 156 is located at ground-level 148. With the ability to utilize multiple different solar panel locations, the power generation system 130 can be customized to the environment and weather of the wind turbine 132 to optimize the amount of electrical energy produced from the system 130.

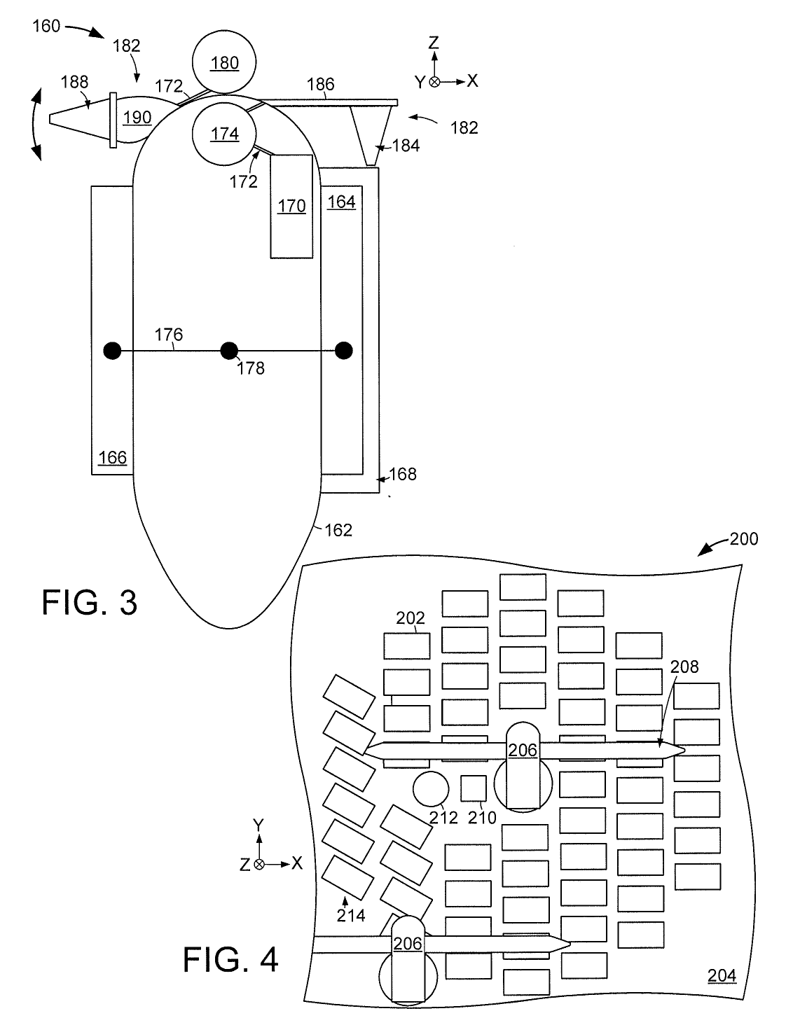

FIG. 3 is a cross-sectional line representation of a portion of an example turbine blade 160 that is suitable for the power generation systems of FIGS. 1 & 2. The turbine blade 160 is constructed of a housing 162 that may be any shape and size to accommodate the harnessing of wind into rotational motion about a hub extending from a nacelle. It is contemplated that the turbine housing 162 is shaped to allow the blade 160 to tilt to provide a variety of different airfoil profiles to oncoming wind.

The turbine housing 162 can support any number of separate, or physically connected, solar panels, such as the first 164 and second 166 panels shown attached to opposite sides of the housing 162. The panels 164 and 166 may be attached to the housing 162 permanently or temporarily, such as via magnets or hook-and-loop fasteners, which can allow for removal and replacement of portions of the panels without damaging the housing 162. A cover assembly 168 can be positioned proximal a solar panel 164 to protect the panel from environmental and operational trauma. The cover assembly 168 may be constructed of rigid and/or flexible materials that reduce the risk of projectiles, such as dust, hail, birds, and debris, from damaging the underlying solar panel 164 and any associated electronics.

It is noted that the cover assembly 168 of FIG. 3 continuously extends to cover multiple different orthogonal sides of the solar panel 164, but such configuration is not required. The cover assembly 168, in some embodiments, is pneumatically operated by a motor 170 that is supplied compressed air via a cover tube 172 extending from a pressurized air supply line 174. The ability to pneumatically control the cover assembly 168 allows a hybrid power generation system to proactively or reactively extend the cover assembly 168 to protect the solar panel 164 without using electricity from the wind turbine directly. That is, potential energy in the form of compressed gas can be used to extend, and retract, the cover assembly 168 instead of an electric motor that would require immediate electricity from the wind turbine generator.

It is contemplated that one or more batteries can also store electricity collected from the solar panels 164 and 166 to be used to operate an electric cover assembly motor alone, or in combination with the pneumatic motor 170. Each solar panel 164 and 166 can be electrically connected to a system controller and/or batteries via one or more electrical pathways 176 and nodes 178 that can pass within the blade housing 162 or external to the housing 162. For instance, a turbine blade 160 can be retrofitted with solar panel(s) 164 without modifying the turbine housing 162 by mounting the panel 164 and all associated electrical pathways 176 on the outside of the housing 162. Similarly, one or more air supply line 180 can be positioned external to the turbine housing 162, as shown. The ability to position an air supply line inside (174) or outside (180) the housing 162 enables retrofitting a wind turbine with pneumatic capabilities without penetrating the turbine housing 162.

The supply of compressed air to the turbine blade 160 allows any number of vectoring features 182 to be positioned throughout the turbine housing 162. In some embodiments, vectoring features 182 are positioned proximal a blade tip, distal the wind turbine nacelle, while other embodiments position vectoring features 182 throughout a trailing, or leading, edge of the turbine blade 160. In the non-limiting embodiment shown in FIG. 3, a first vectoring feature 182 has a first nozzle 184 attached to the turbine housing 162 via a static mount 186 while a second vectoring feature 182 has a second nozzle 188 connected to the turbine housing 162 via a pivot 190.

While the number, size, position, and function of vector feature(s) 182 is not limited, at least one nozzle, such as the first nozzle 184, can be positioned proximal a solar panel 164 to allow expelled compressed air to clean the exposed surface(s) of the solar panel 164. The position of a vectoring feature 182 proximal the solar panel 164 may further allow compressed air to be used to protect solar panel 164 from damage by continuously passing compressed air over the solar panel 164. That is, the flow of compressed air over the solar panel 164 can deflect, or slow, debris heading towards the light sensitive portions of the solar panel 164.

The first nozzle 184 may be static and can be complemented by one or more dynamic nozzles 188 that can rotate, tilt, and move to expel compressed air in multiple different directions. The position and direction of the dynamic nozzle 188 can be articulated about the pivot 190 to modify the operation of the turbine blade 160 as well as clean and protect at least one solar panel 166. For example, the pivot 190 may be electrically or pneumatically operated by a controller to point the dynamic nozzle 188 in a direction that slows down or speeds up rotation of the turbine blade 160 around the nacelle and turbine generator. The capability of changing the position of the dynamic nozzle 188 can reduce the overall number of nozzles needed on a turbine blade 160, which can reduce system complexity and aerodynamic drag.

FIG. 4 is a top view line representation of an example hybrid power generation system 200 that employs a plurality of solar panels 202 at ground level 204. At least one wind turbine 206 can be positioned anywhere relative to the solar panels 202 with a turbine blade 208 rotating above at least some of the solar panels 202. The wind turbine 206 can generate electricity that operates at least one compressor 210 to occupy a pressure vessel 212 with a volume of compressed air.

The stored compressed air can be used to pneumatically clean and/or move one or more solar panels 202 to optimize the collection of solar energy. As illustrated, at least one column 214 of solar panels 202 can be rotated relative to other panels 202 via electric or pneumatic motors. The ability to tilt, rotate, and move any one, or more, solar panels 202 can maximize the collection of solar energy as the sun travels throughout the day. Moving solar panel(s) 202 may further allow one or more pneumatic nozzles to efficiently clean dust, dirt, and debris from the light sensitive portions of the solar panels 202, as opposed to static panels that would need at least one nozzle per panel.

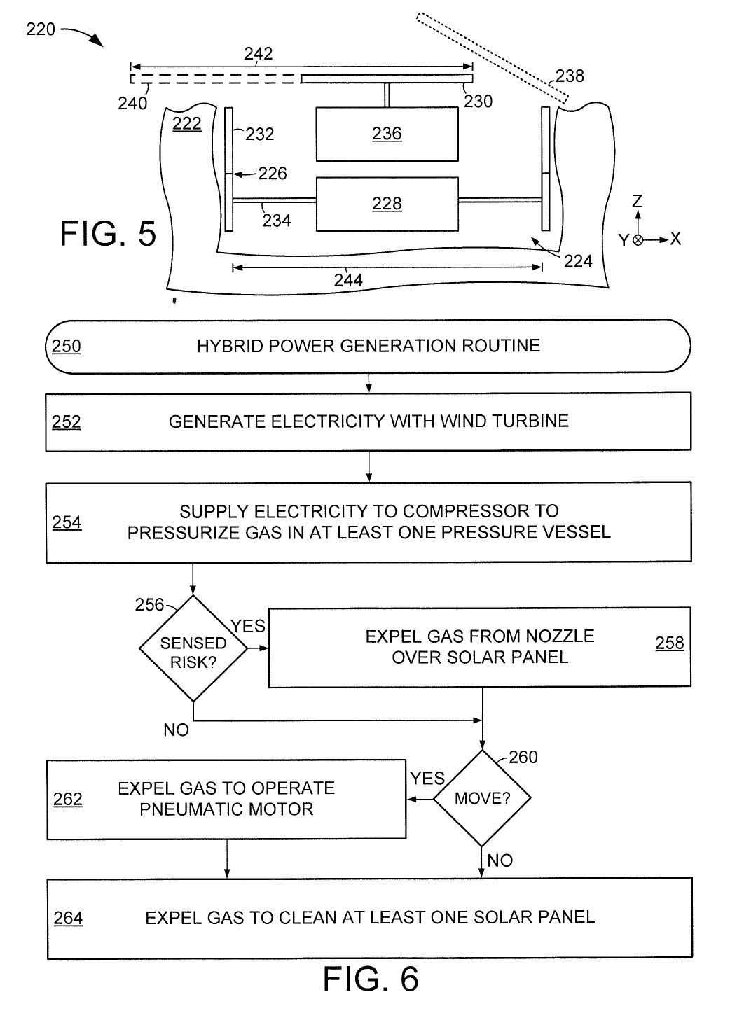

FIG. 5 displays a side view line representation of a portion of an example nacelle 220 suitable for use in a hybrid power generation system in accordance with some embodiments. The nacelle 220 has a housing 222 that encloses a panel deployment system 224 with at least one door 226. In response to a controller, a door motor 228 can open, or close, the respective doors 226 to expose at least one solar panel 230 to external solar energy. It is contemplated the door 226 comprises multiple articulable segments 232, such as a garage door, and is connected to the motor 228 via a sealed tube 234.

The door motor 228 may also articulate the solar panel 230, such a along the Z axis to a plane external to the nacelle housing 222. However, some embodiments employ a separate panel motor 236 that pneumatically, or electrically, moves the solar panel 230. Regardless of how the solar panel 230 is moved, a system controller can dictate that the panel 230 tilts, as shown by segmented position 238, and/or extends, as shown by segmented portion 240. In the event the solar panel 230 extends with portion 240, the solar panel 230 may have an overall light collecting length 242, along the X axis, that is greater than the door opening length 244. The expansion of a solar panel 230 can take advantage of optimal solar conditions without jeopardizing the solar panel 230, such as with windy conditions, the presence of birds, or the presence of flying debris.

It is noted that FIG. 4 displays multiple separate wind turbines 206. A hybrid power generation system, in various embodiments, can have any number of separate wind turbines 206 connected to a common, or independent, controllers. A plurality of wind turbines 206 can be similarly configured, or different, while sharing equipment or having independent solar and pneumatic features. For example, multiple wind turbines 206 can share a common compressor and/or pressure vessel or may be arranged with separate and independent compressors and pressure vessels that are arranged with different air compressing capabilities and volumes.

A flowchart of an example hybrid power generation routine 250 is provided in FIG. 6. The various aspects of routine 250 are not required or limited and may be carried out by various embodiments shown and discussed in FIGS. 1-5. Initially, the power generation routine 250 generates electricity with at least one wind turbine in step 252. The electricity produced from rotating turbine blades can be stored locally, such as with batteries and/or capacitors, supplied to a power grid, or immediately consumed. Irrespective of the manner of electrical transmission, step 254 subsequently uses electricity to compress air with one or more compressors and fill at least one pressure vessel to a predetermined pressure, such as 250 psi.

While compressed air can be stored for any amount of time, various embodiments employ the compressed air. Decision 256 evaluates and determines if a risk is present to the wind turbine or a solar panel proximal the wind turbine. A risk may be predicted, such as wind or hail, or sensed via at least one sensor, such as the presence of birds. A risk can prompt a controller to activate at least one nozzle in step 258 to expel compressed gas over at least a solar panel. In some embodiments, compressed air is used in step 258 to operate a animal repellant, such as a whistle and/or sonic device. It is contemplated that step 258 can utilize compressed air to operate one or more vibrating vanes on, or around, the turbine blades to deter birds from flying proximal the wind turbine. The ability to selectively activate bird deterring elements can be important since there are some sites that turbines are not used due to the delicate bird population or migration channels. Hence, the pneumatic capabilities of a wind turbine can proactively predict, or reactively sense, the presence of birds and activate at least one deterring countermeasure to prevent harm to the birds or any portion of the wind turbine, including the turbine blades and solar panels.

The expelled compressed gas in step 258 may also pass over portions of the turbine blade(s) to protect them from damage. Moving air can also be used to activate an alarm in step 258 to deter animals, such as bugs and birds, from flying close to the wind turbine. At the conclusion of the predicted or sensed risk, or in the event no risk is present, routine 250 decides whether or not to move portions of the hybrid power generation system in decision 260, such as a solar panel and/or turbine blade. A determination that something is to be moved advances to step 262 where expelled compressed gas is used to operate a pneumatic motor to articulate a solar panel and/or a turbine blade. For example, a solar panel may be extended or tilted or a turbine blade may be sped up or slowed down as a result of passing compressed gas out of a nozzle or into a motor.

At some time after portions of a power generation system are moved, or if no movement is called for from decision 260, step 262 expels compressed gas from a local pressure vessel to clean at least one solar panel. The solar panel may be located on a turbine nacelle, on the ground, or on a turbine blade. It is noted that the cleaning of a solar panel may involve activation of a cleaning liquid nozzle, which can dispense an emulsifying cleaner that allows moving compressed air to more efficiently clean the solar panel than liquid or moving air alone.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular application without departing from the spirit and scope of the present invention.

What is claimed is:

1. An apparatus comprising:
a wind turbine having at least one blade connected to an electrical generator, the wind turbine connected to a controller;
a pressure vessel pneumatically connected to at least one nozzle attached proximal the wind turbine;
a compressor connected to the pressure vessel and the controller, the compressor operated via electricity produced by the electrical generator; and
at least one solar panel positioned proximal the at least one nozzle to clean the at least one solar panel with compressed air from the pressure vessel in response to the controller.

2. The apparatus of claim 1, wherein the electrical generator is positioned in a nacelle of the wind turbine.

3. The apparatus of claim 1, wherein the at least one nozzle is statically mounted to the at least one blade.

4. The apparatus of claim 1, wherein the at least one nozzle is mounted to the at least one blade via a pivot configured to tilt the at least nozzle relative to the at least one solar panel.

5. The apparatus of claim 1, wherein the at least one nozzle is supplied compressed air by a supply line, the supply line continuously extending within a blade housing of the at least one blade.

6. The apparatus of claim 1, wherein the at least one nozzle is supplied compressed air by a supply line, the supply line continuously extending within a blade housing of the at least one blade.

7. The apparatus of claim 1, wherein a first nozzle of the at least one nozzle is attached to a first blade of the at least one blade and a second nozzle of the at least one nozzle is attached to a second blade of the at least one blade.

8. The apparatus of claim 1, wherein a cover continuously extends proximal a light sensitive portion of the at least one solar panel.

9. The apparatus of claim 8, wherein the cover continuously extends along multiple orthogonal sides of the at least one solar panel.

10. The apparatus of claim 8, wherein the cover is pneumatically operated and is connected to a pneumatic motor.

11. The apparatus of claim 1, wherein the at least one solar panel is connected to a pneumatic motor, the pneumatic motor configured to tilt the at least one solar panel relative to the at least one blade.

12. An apparatus comprising:
first and second wind turbines each having a plurality of blades connected to an electrical generator, each wind turbine connected to a controller;
first and second pressure vessels pneumatically connected to a first nozzle attached proximal the first wind turbine and a second nozzle attached proximal the second wind turbine;
a compressor connected to the first and second pressure vessels and the controller, the compressor operated via electricity produced by at least one electrical generator of the first or second wind turbines;
a first solar panel positioned proximal the first nozzle to clean the first solar panel with compressed air from the first pressure vessel in response to the controller; and
a second solar panel positioned proximal the second nozzle to move the second solar panel relative to the second wind turbine.

13. The apparatus of claim 12, wherein the plurality of nozzles for the first wind turbine comprises multiple different nozzle sizes.

14. The apparatus of claim 12 wherein the plurality of nozzles of the first wind turbine comprises different first and second types of nozzles.

15. The apparatus of claim 12, wherein the first solar panel is positioned on a ground surface, physically separated from the first and second wind turbines.

16. The apparatus of claim 12, wherein the second solar panel is attached to a nacelle of the second wind turbine.

17. The apparatus of claim 12, wherein the first pressure vessel is positioned within a tower of the first wind turbine.

18. The apparatus of claim 12, wherein the second pressure vessel is a geologic formation positioned underground.

19. An apparatus comprising:
a wind turbine having at least one blade connected to an electrical generator, the wind turbine connected to a controller;
a pressure vessel pneumatically connected to at least one nozzle attached proximal the wind turbine;
a compressor connected to the pressure vessel and the controller, the compressor operated via electricity produced by the electrical generator;
at least one solar panel positioned proximal the at least one nozzle to clean the first solar panel with compressed air from the pressure vessel in response to the controller; and
at least one sensor connected to the controller and configured to detect risk of damage to the at least one solar panel.

20. The apparatus of claim 19, wherein first and second sensors of the at least one sensor are connected to the controller, the first sensor being different than the second sensor and physically separated from the second sensor.
